(19) United States
(12) Patent Application Publication
(10) Pub. No.: US 2015/0327724 A1
(43) Pub. Date: Nov. 19, 2015

(54) CYLINDRICAL COOKER

(71) Applicants: Jong Yon JO, Yeonsu-gu Incheon (KR); In Ho KIM, (US)

(72) Inventors: Jong Yon JO, Seoul (KR); In Ho KIM, Seoul (KR)

(21) Appl. No.: 14/426,532

(22) PCT Filed: Jul. 3, 2013
(86) PCT No.: PCT/KR2013/005897

§ 371 Date: Mar. 6, 2015

(30) Foreign Application Priority Data
Aug. 22, 2012 (KR) 10-2012-0091600
May 29, 2013 (KR) 10-2013-0060871

(51) Int. Cl. A47J 37/12

(52) U.S. Cl. CPC A47J 37/129

(57) ABSTRACT

A cylindrical cooker is provided. The cooker includes: a cooking pan; a housing; one or more supports; and a cooking pan cover. The cooking pan includes a protrusion part extended upwardly from the bottom surface at the center, forming cooking space between the inner wall of the cooking pan and the protrusion part. The protrusion part includes a force transfer unit. The housing is shaped to be open at the top. The housing includes: a rotation shaft for transmitting rotational force from a motor to the force transfer unit; a heater for heating the inside surface of the protrusion part or the outer sidewall of the cooking pan and a cooking pan receiving part for receiving the cooking pan. The supports support the cooker from the floor at an angle between the floor and the cooker when it is laid down. The cooking pan cover includes a locking unit.

### TECHNICAL FIELD

The invention relates to a cylindrical cooker including: a housing, a cooking pan, and a cooking pan cover. The housing is shaped to be open at the top, which serves to receive the cooking pan. The housing can be laid at an angle by a support. The housing includes a rotation shaft for receiving rotational force from a motor with respect to the axis of the housing. The cooking pan includes: a shaft rotated by rotational force transferred from the rotational shaft of the housing via a force transfer unit and a vertically turning plate on the inner wall. The cooking pan cover is locked and unlocked to and from the force transfer unit of the cooking pan. The cooking pan cover is rotated with the cooking pan when it is locked or unlocked.

The invention also relates to a cylindrical cooker including: a cooking pan, a housing, supports, cooking pan handles and a cooking pan cover. The cooking pan includes a protrusion part extended upwardly from the bottom surface at the center, forming a cooking space between the inner wall of the cooking pan and the top side and the lateral side of the protrusion part. The protrusion part includes a force transfer unit. The housing is shaped to be open at the top. The housing includes: a rotation shaft for transferring rotational force from a motor to the force transfer unit; a heater, installed to the inner wall, for heating the outer wall of the cooking pan; and a cooking pan receiving part for receiving the cooking pan, wherein the cooking pan receiving part serves as the inner wall. The supports are installed to the outer sidewall of the housing. The supports support the cooker from the floor at an angle between the floor and the cooker when the cooker is laid down. The heater is placed at an outer side wall of the cooking pan rotating when the cooker is laid down. The cooking pan handles are located, at the top rim of the cooking pan, opposite each other. Each of the cooking pan handles includes a locking member. The cooking pan cover covers the top of the cooking pan. The cooking pan cover is rotated with the cooking pan when the cooking pan cover is locked or unlocked by the locking member.

### BACKGROUND ART

Conventional cookers are designed so that they include: a housing forming a cavity on the top and include a heater for heating the bottom or the inner side; a cooking pan placed in the cavity; and a cover for covering the top of the cooking pan.

For example, pressure cookers or electric rice cookers, etc., are designed in such a way that they are operated in a state where the housing and the cooking pan are vertically placed. The housing includes a heater in the wall or the bottom, and receives the cooking pan. When material is cooked in the cooking pan, it is intensively heated only near the heater, so it may be burned or may not be uniformly cooked. In particular, since conventional cookers are designed in such a way that they must place a mesh on the base to cook an oily material, they cannot allow oil to be discharged from the material, or it may become burned. This deteriorates the taste of the material.

Korean Utility Registration No. 20-0458280 disclosed a cooker designed in such a way that it is horizontally placed on the floor and heats material, for example, a popped rice cake (called Pung Teui Gi in Korean) machine. Since conventional cookers must be horizontally maintained during cooking, they can be limited to types of materials.

### DISCLOSURE OF INVENTION

### Technical Problem

The invention solves the above problems, and provides a cylindrical cooker designed in such a way that: the housing with a heater receives a cooking pan in the cooking pan receiving part; the cooking pan is rotated with respect to the rotation shaft installed to the cooking pan receiving part; and the housing of the cooker is inclined via a support, so that the cooking pan is also inclined and can cook material while it is rotating, thereby preventing the material from being burned.

The invention further provides a cylindrical cooker designed in such a way that a vertically turning plate is vertically installed on the inner wall of the cooking pan and prevents material from being stuck on the wall or massing during cooking, thereby evenly heading the material.

The invention further provides a cylindrical cooker designed in such a way that: the vertically turning plate is installed to the cooking pan so that the lower end of the plate is above at a height from the bottom of the cooking pan, into which an oil discharging plate for discharging oil and a guiding groove are inserted; and the oil discharging plate with a number of holes is turned and locked to the lower end of the vertically turning plate so that the vertically turning plate is mismatched with the guiding groove, so it can be used stably without being dislodged therefrom.

The invention further provides a cylindrical cooker designed in such a way that the support serves as a support and handle, so that it can support the housing at an inclination of an angle and also be carried by the user's hand.

The invention further provides a cylindrical cooker designed in such a way that: a protrusion part extends upward from the bottom surface of the cooking pan; the protrusion part forms the lower space; and a heater, fixedly placed in the bottom of the cooking pan receiving part of the housing, heats the inside surface of the lower space of the protrusion part, so that heat is not transferred to the outer wall of the housing and thus this prevents the user from getting burned and doesn't require a thermal insulation for preventing burns.

The invention further provides a cylindrical cooker that: can reduce frictional force by the rotation of a cooking pan between the cooking pan and the inner wall of the housing; can prevent noise; and match the cooking pan and the housing in the same axis so that the cooker can perform a cooking operation in a certain pose and a spacing therebetween, thereby guaranteeing the cooking time and allowing the cooking pan to evenly cook material.

The invention further provides a cylindrical cooker designed in such a way that: supports are installed to the housing; a heater is installed to the inside wall serving as a cooking pan receiving part of the housing; the cooking pan is rotated with respect to the rotation shaft installed to the cooking pan receiving part; and the housing of the cooker is inclined via the supports, so that the cooking pan is also inclined and can cook material while it is rotating, thereby preventing the material from being burned.

The invention further provides a cylindrical cooker designed in such a way that: the vertically turning plate is installed to the inner wall of the cooking pan so that the lower end of the plate is above at a height from the bottom of the cooking pan to prevent material from being damaged; an oil discharging hole is formed at the lower wall of the vertically turning plate to discharge oil to the outside; and an oil discharging container receives oil discharged from the hole, thereby cooking delicious and healthy food.

### Solution to Problem

In accordance with an exemplary embodiment of the invention, there is provided a cylindrical cooker including: a cooking pan; a housing; a support; and a cooking pan cover. The cooking pan includes a protrusion part extended upwardly from the bottom surface at the center, forming cooking space between the inner wall of the cooking pan and the protrusion part. The protrusion part includes a force transfer unit. The housing is shaped to be open at the top. The housing includes: a rotation shaft for transmitting rotational force from a motor to the force transfer unit; a heater for heating the inside surface of the protrusion part; and a cooking pan receiving part for receiving the cooking pan. The support supports the cooker from the floor at an angle between the floor and the cooker when it is laid down. The cooking pan cover includes a locking unit. The locking unit is locked and unlocked to and from a locking head of the force transfer unit. The cooking pan cover is rotated with the cooking pan when it is locked or unlocked.

In accordance with another exemplary embodiment of the invention, there is provided a cylindrical cooker including: a cooking pan; a housing; supports; a pair of cooking pan handles; and a cooking pan cover. The cooking pan includes a protrusion part extended upwardly from the bottom surface at the center, forming cooking space between the inner wall of the cooking pan and the top side and the lateral side of the protrusion part. The protrusion part includes a force transfer unit. The housing is shaped to be open at the top. The housing includes: a rotation shaft for transferring rotational force from a motor to the force transfer unit; a heater, installed to the inner wall, for heating the outer wall of the cooking pan and a cooking pan receiving part for receiving the cooking pan. The cooking pan receiving part serves as the inner wall. The supports are installed to the outer sidewall of the housing. The supports support the cooker from the floor at an angle between the floor and the cooker when the cooker is laid down. The heater is placed at an outer side wall of the cooking pan rotating when the cooker is laid down. The cooking pan handles are located, at the top rim of the cooking pan, opposite each other. Each of the cooking pan handles includes a locking member. The cooking pan cover covers the top of the cooking pan. The cooking pan cover is rotated with the cooking pan when the cooking pan cover is locked or unlocked by the locking member.

### Advantageous Effects of Invention

As described above, the cylindrical cooker according to the invention is designed in such a way that: the housing with a heater receives a cooking pan in the cooking pan receiving part; the cooking pan is rotated with respect to the rotation shaft installed to the cooking pan receiving part; and the housing of the cooker is inclined via a support, so that the cooking pan is also inclined and can cook material while it is rotating, thereby preventing the material from being burned.

The cylindrical cooker according to the invention is designed in such a way that a vertically turning plate is vertically installed on the inner wall of the cooking pan and prevents material from being stuck on the wall or massing during cooking, thereby evenly heating the material.

The cylindrical cooker according to the invention is designed in such a way that: the vertically turning plate is installed to the cooking pan so that the lower end of the plate is above at a height from the bottom of the cooking pan, into which an oil discharging plate for discharging oil and a guiding groove are inserted; and the oil discharging plate with a number of holes is turned and locked to the lower end of the vertically turning plate so that the vertically turning plate is mismatched with the guiding groove, so it can be used stably without being dislodged therefrom.

The cylindrical cooker according to the invention is designed in such a way that the support serves as a support and handle, so that it can support the housing at an inclination of an angle and also be carried by the user's hand.

The cylindrical cooker according to the invention is designed in such a way that: a protrusion part extends upward from the bottom surface of the cooking pan; the protrusion part forms the lower space; and a heater, fixedly placed in the bottom of the cooking pan receiving part of the housing, heats the inside surface of the lower space of the protrusion part, so that heat is not transferred to the outer wall of the housing and thus this prevents the user from getting burned and doesn't require a thermal insulation for preventing burned.

The cylindrical cooker according to the invention: can reduce frictional force by the rotation of a cooking pan between the cooking pan and the inner wall of the housing; can prevent noise; and match the cooking pan and the housing in the same axis so that the cooker can perform a cooking operation in a certain pose and a spacing therebetween, thereby guaranteeing the cooking time and allowing the cooking pan to evenly cook material.

The cylindrical cooker according to the invention is designed in such a way that: supports are installed to the housing; a heater is installed to the inside wall serving as a cooking pan receiving part of the housing; the cooking pan is rotated with respect to the rotation shaft installed to the cooking pan receiving part; and the housing of the cooker is inclined via the supports, so that the cooking pan is also inclined and can cook material while it is rotating, thereby preventing the material from being burned.

The cylindrical cooker according to the invention is designed in such a way that: the vertically turning plate is installed to the inner wall of the cooking pan so that the lower end of the plate is above at a height from the bottom of the cooking pan to prevent material from being damaged; an oil discharging hole is formed at the lower wall of the vertically turning plate to discharge oil to the outside; and an oil discharging container receives oil discharged from the hole, thereby cooking delicious and healthy food.

### BRIEF DESCRIPTION OF DRAWINGS

The features and advantages of the invention will become more apparent from the following detailed description in conjunction with the accompanying drawings, in which

FIG. 1 is a perspective view showing a cylindrical cooker according to an embodiment of the invention;

FIG. 2A is a cross-sectional perspective view of the cooker shown in FIG. 1, taken along line A-A;

FIG. 2B is a cross-sectional view of the cooker shown in FIG. 1, taken along line A-A;

FIG. 3A is a cross-sectional perspective view of the cooker shown in FIG. 1, taken along line B-B;

FIG. 3B is a cross-sectional view of the cooker shown in FIG. 1, taken along line B-B;

FIG. 4 is a perspective view showing the cylindrical cooker with the removal of the cooking pan cover;

FIG. 5 is a perspective view showing the inner plate shown in FIG. 4;

FIG. 6 is a perspective view showing a plate for locking the cover according to an embodiment of the invention;

FIG. 7 is a perspective view showing the locking plate coupled to a force transfer unit via the locking head;

FIG. 8 is a perspective view showing the cooking pan, seen from the bottom side;

FIG. 9 is a primary perspective view of the force transfer unit coupled to the protrusion part according to an embodiment of the invention;

FIG. 10 is a side view showing the cooker according to an embodiment of the invention when it is in use;

FIG. 11 is an exploded perspective view showing a cylindrical cooker according to another embodiment of the invention;

FIG. 12 is a cross-sectional view of the cooker shown in FIG. 11, taken along line 2A-2A;

FIG. 13 is a cross-sectional view of the cooker shown in FIG. 12, taken along line 2B-2B;

FIG. 14 is a cross-sectional view of the cooker shown in FIG. 12, taken along line 2C-2C;

FIG. 15 is a primary perspective view showing a force transfer unit according to another embodiment of the invention;

FIG. 16 is an enlarged cross-sectional view showing the cooking pan handle coupled to the cooker shown in FIG. 11;

FIG. 17 is a perspective view showing the block shown in FIG. 11; and

FIG. 18 is an enlarged cross-sectional view showing the roller shown in FIG. 11.

### BRIEF DESCRIPTION OF SYMBOLS IN THE DRAWINGS

10: protrusion part 11: center hole

12: inside space 20: force transfer unit

21: angled groove 23: hollow bolt

24: supporting unit 26: locking neck

27: locking head 28: screw nut

30: cooking pan 31: cooking space

32: vertically turning plate 35: oil discharging plate

36: guiding groove 37: through-hole

38: spacing bar 39: oil discharging hole

40: housing 40-1: inner wall

40-2: inner wall oil discharging hole 40-3: outer sidewall

41: motor 42: heater

42-1: heater body 42-2: thermal insulating plate

42-3: auxiliary reflection plate 42-4: curved net

43: rotation shaft 44: cooking pan receiving part

45: roller 49: oil discharging container

49a: spatula 50: support

51: extension bar 52: handle bar

53: foot 55: long extension bar

56: short extension bar 60: locking unit

61: cover locking hole 70: cooking pan cover

80: cooking pan handle 85: locking member

90: block 91: block valve

92: protrusion handle

### BEST MODE FOR CARRYING OUT THE INVENTION

The invention provides a cylindrical cooker designed in such a way that: the housing with a heater receives a cooking pan in the cooking pan receiving part; the cooking pan is rotated with respect to the rotation shaft installed to the cooking pan receiving part; and the housing of the cooker is inclined via a support, so that the cooking pan is also inclined and can cook material while it is rotating, thereby preventing the material from being burned.

### MODE FOR THE INVENTION

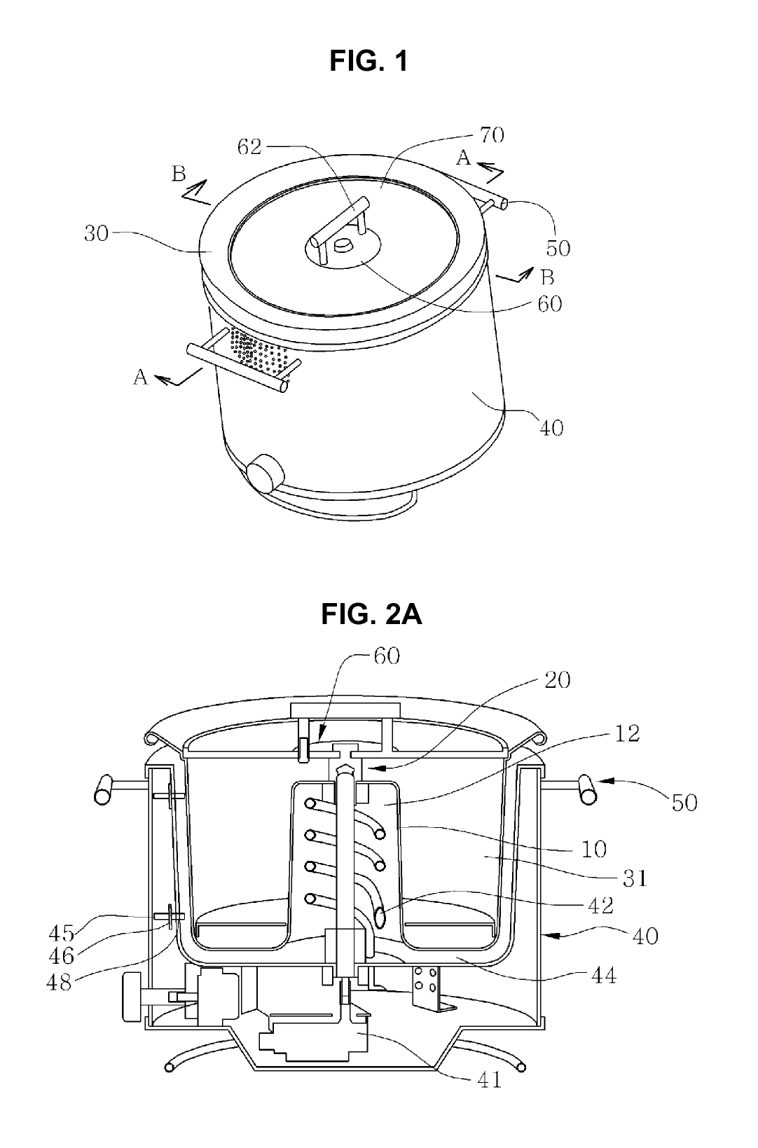

Hereinafter, an embodiment of the invention is described in detail with reference to the accompanying drawings FIGS. 1 to 10.

The cylindrical cooker includes: a cooking pan 30; a housing 40; a support 50; and a cooking pan cover 70.

The cooking pan 30 includes a protrusion part 10 extended upwardly from the bottom surface at the center, forming cooking space 31 between the inner wall of the cooking pan 30 and the protrusion part 10. The protrusion part 10 includes a force transfer unit 20.

The housing 40 is shaped to be open at the top. The housing 40 includes: a rotation shaft 43 for transmitting rotational force from a motor 41 to the force transfer unit 20; a heater 42 for heating the inside surface of the protrusion part 20; and a cooking pan receiving part 44 for receiving the cooking pan 30.

The support 50 supports the cooker from the floor at an angle between the floor and the cooker when it is laid down.

The cooking pan cover includes a locking unit 60. The locking unit 60 is locked and unlocked to and from a locking head 27 of the force transfer unit 20. The cooking pan cover 70 is rotated with the cooking pan 30 when it is locked or unlocked.

The force transfer unit 20 includes: a hollow bolt 23; a supporting unit 24; a locking neck 26; and a locking head 27.

The hollow bolt 23 is formed with an angled groove 21. The hollow bolt 23 extends through a center hole 11 of the protrusion part 10 to the inside space 12, and receives rotational force from the rotation shaft 43 of the lower side center.

The supporting unit 24 is integrally formed at the top end of the hollow bolt 23. The supporting unit 24 extends through the outer surface of the protrusion part 10.

The locking neck 26 is formed on the upper end of the supporting unit 24 at the center. The locking neck 26 guides a cover locking groove 61 when the cover is locked or unlocked.

The locking head 27 is integrally formed at the upper end of the locking neck 26 and fitted into the cover locking groove 61 to extend and protrude out of the surface of the cooking pan cover 70.

The supporting unit 24 of the force transfer unit 20 has a diameter greater than the length of the locking head 27 to support the center of the cooking pan cover 70.

The cooking pan 30 further includes one or more vertically turning plates 32 on the inner wall.

The cooker further includes an oil discharging plate 35. The oil discharging plate 35 is formed with a guiding groove 36 for guiding the oil discharging plate 35 to be fitted to the lower side of the cooking space 31 along the vertically turning plate 32. The oil discharging plate 35 is installed in the cooking space 31, spaced apart from the bottom of the cooking pan 30 at a distance. The oil discharging plate 35 is formed with a number of through-holes 37 for allowing oil created during cooking to flow toward the bottom of the cooking pan 30.

The vertically turning plate 32 is installed so that the lower end is above the level of oil discharge height from the bottom of the cooking space 31.

The vertically turning plate 32 includes a spacing bar 38 around the rim on the lower side for retaining the vertically turning plate 32 spaced apart from the oil discharge height from the bottom of the cooking space 31.

The support 50 includes: a pair of extension bars 51 extended from the outer side of the housing 40 at the upper location in the horizontal direction when the cooker is placed on the floor; and a handle bar 52, connecting the ends of the extension bars 51, for supporting the housing 40 from the floor when the cooker is laid down.

The cooking pan receiving part 44 includes rollers 45 around and on the wall. The rollers 45 allow the cooking pan 30 to be rotated in the cooking pan receiving part 44 with respect to the center axis of the housing 40.

As shown in FIG. 10, the support 50 supports the cooker from the floor P1 between the floor and the cooker when it is laid down at a range of tilt angle, preferably 5˜15°. If the tilt angle is less than 5°, it increases the cooking time and cooks material unevenly. On the contrary, if the tilt angle is greater than 15°, it can decrease the cooking time; however the material could be burned or partially overheated.

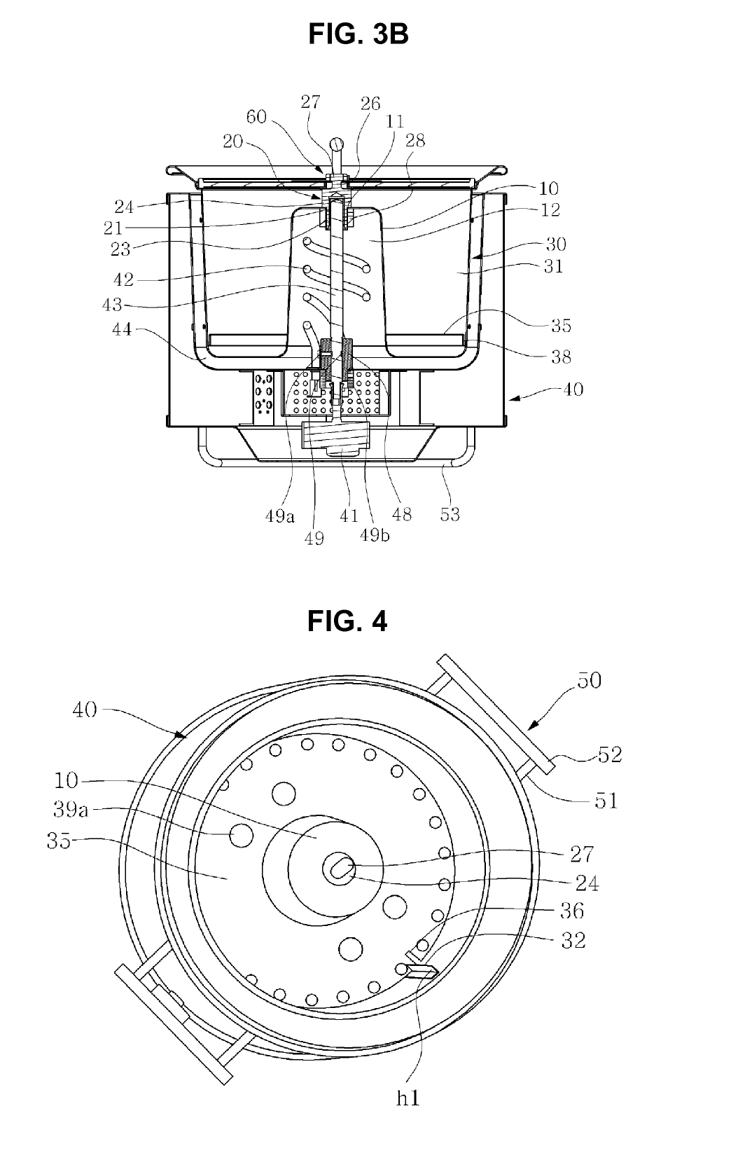

As shown in FIGS. 3A and 4, the vertically turning plate 32 is protruded from the inner wall of the cooking pan 30 at a range of height, h1, preferably 6˜10 mm. If the height is less than 6 mm, material is not turned well and thus is unevenly cooked. On the contrary, if the height is greater than 10 mm, material is damaged on the surface.

The rotation shaft 43 is coupled to the shaft of the motor 41. In order to prevent the rotation shaft 43 from running at an excessive speed, it is preferable that the motor 41 is implemented with a lower speed motor, a geared motor, or a motor with a speed reduction gear. Therefore, the rotation shaft 43 can be rotated at a low speed. The rotational force is transferred from the motor to the rotation shaft 43 via an angled groove 21 of the force transfer unit 20. The rotation shaft 43 may be designed to form a number of holes for emitting heat shaped as pipes, so as not to over-heat. Although the embodiment of the invention is implemented in such a way that the angled groove 21 is shaped as an angled form, it may also be noted that the angled groove 21 may be a key spline. The cooker may also include a foot 53 for supporting the housing 40 when it is upright.

When the cooker is used for cooking, the rotation shaft 43 and the spiral heater 42 (e.g., sheath heater, carbon heater, halogen heater, etc.) are extended upwardly from the bottom of the cooking pan receiving part 44 at the center.

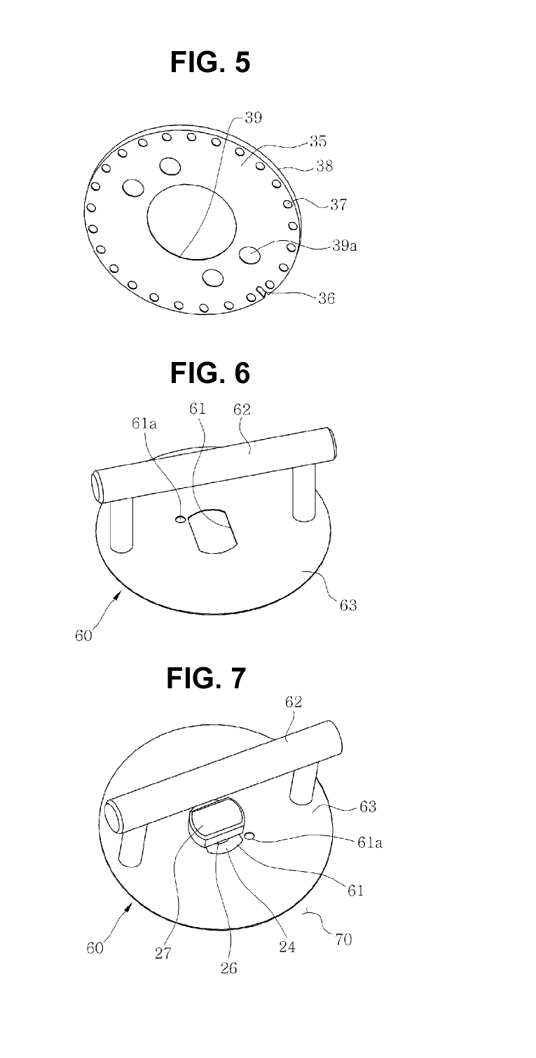

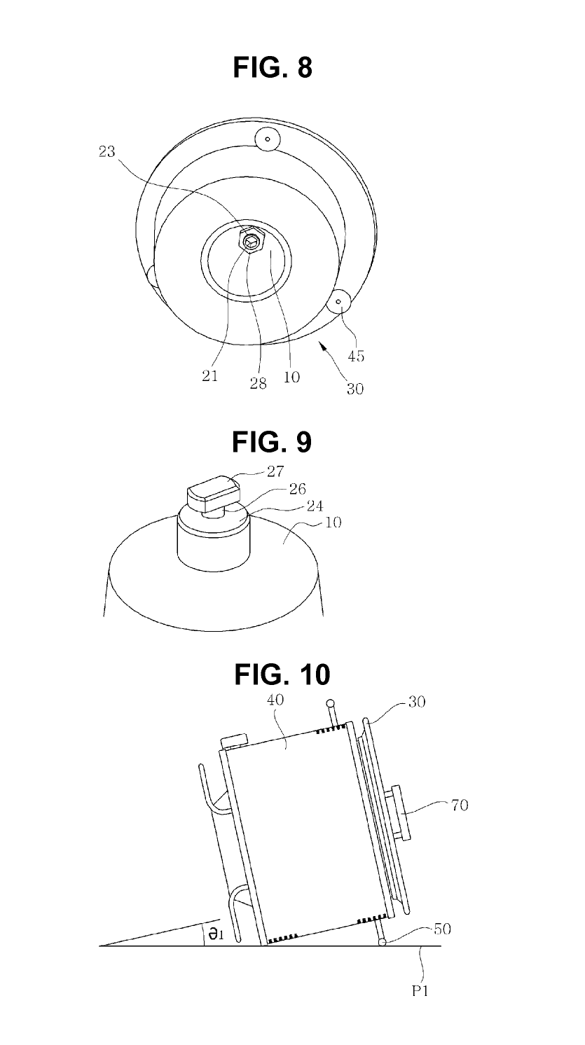

The rotation shaft 43, shaped as angles, is fitted into the angled groove 21 in the inside space 12 of the protrusion part 10 of the cooking pan 30 as shown in FIG. 8. FIG. 4 shows a perspective view of the cylindrical cooker when the rotation shaft 43 is fitted into the angled groove 21. FIG. 4 also shows the oil discharging plate 35 shown in FIG. 5 and the vertically turning plate 32. The vertically turning plate 32 is connected to the oil discharging plate 35 via the guiding groove 36. If the vertically turning plate 32 is connected to the oil discharging plate 35, the user grips the handle holes 39a of the oil discharging plate 35 with his/her fingers and turns it, thereby tightly coupling them to each other since the guiding groove 36 and the vertically turning plate 32 are not matched in the vertical direction. Since the lower portion of the rim of the oil discharging plate 35 serves as a spacing bar 38, it is spaced at a height from the bottom of the cooking space 31.

In that case, the force transfer unit 20, including a supporting unit 24, a locking neck 26 and a locking head 27, is protruded on the upper side of the protrusion part 10. The locking unit 60, as shown in FIG. 6, is coupled with the cooking pan cover 70 at the center on the upper surface in such a way that the cover locking hole 61 of the locking unit 60 is fitted with the locking head 27 of the cover 70 in the lengthwise direction. After that, the handle 62 is turned so that the locking unit 60 can be tightly coupled to the cooking pan cover 70 as shown in FIG. 7. Since the locking hole 61 is shaped as a rectangle and the locking head 27 is also shaped as a rectangle corresponding to the shape of the locking hole 61, they are arranged at the initial step so that their shapes match. After that, the handle 62 is turned on the cooking pan cover 70 and the turning is stopped so that it is located as shown in FIG. 7. That is, the lengthwise part of the locking head 27 is located to cross that of the cover locking hole 61, so that the locking unit 60 can be tightly coupled to the cooking pan cover 70. The supporting unit 24 has a diameter greater than the lengthwise length of the cover locking hole 61, thereby sealing the cooking pan cover 70. Before the locking unit locks the cooking pan cover 70, material to be cooked should be put in the cooking pan 30.

When the cooking pan cover 70 is locked to the cooking pan 30 via the locking unit 60, the cooking pan 30 is placed in the housing 40 so that they have the same axis, via a number of rollers 45 that are installed on the inner wall of the cooking pan receiving part 44 and are spaced apart from each other at a certain distance. As shown in FIG. 10, when the cooker is laid down and supported via the support 50 from the floor P1 at an angle (e.g., 5˜15°, it may be operated by turning on the electric power switch and a control sensor. In an embodiment of the invention, although the supports 50 also serve as handles, the handles may be separately implemented from the supports, for example, separate jigs.

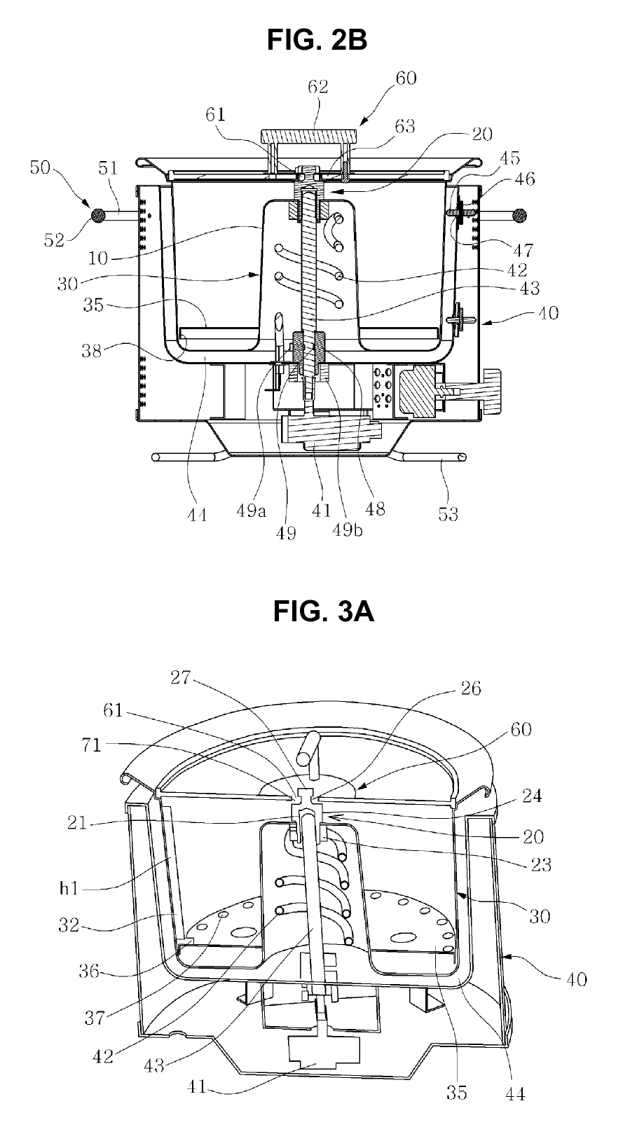

As shown in FIGS. 2A and 2B and 3A and 3B, the heater 42 heats the cooking pan 30 and the motor 41 rotates the shaft at a lowered speed. The rotational force is transferred from the rotation shaft 43 to the force transfer unit 20. The force transfer unit 20, integrally installed to the protrusion part 10 of the cooking pan 30, rotates the cooking pan 30. When the cooking pan 30 with an inclination of an angle with respect to the floor is rotated, the vertically turning plate 32, installed on the inner wall of the cooking pan 30, naturally turns over material. Therefore, the material in the cooking pan 30 is evenly and completely cooked without burning. In an embodiment of the invention, the vertically turning plate 32 is protruded from the inner wall of the cooking pan 30 at a range of height, h1, e.g., 6˜10 mm. Therefore, the cooker can evenly cook soft material, such as fish, without damaging it. When the cooker cooks meat that may ooze during cooking, it can discharge oil from the meat to the bottom of the cooking pan 30 via the through-hole 37 of the oil discharging plate 35. Therefore, the meat can be cooked without contacting the oozed oil, and this enhances the taste of the cooked meat.

The cooker according to the invention is designed in such a way that: the rotation shaft 43 is extended upward from the center bottom of the housing 40 and the heater 42 is also installed in the same protrudent way from the bottom to be placed under the inside space 12 of the protrusion part 10 of the cooking pan 30. During cooking, the heater 42 heats the inner wall of the cooking pan 30. In that case, heat is transferred from the inner wall of the cooking pan 30 to the outer wall, i.e., cooking space 31 of the protrusion part 10. Therefore, since the amount of heat transferred from the outside wall of the cooking pan 30 to the inner wall of the housing 40 is relatively small, the cooker does not need an additional thermal isolation or isolation member, and this can reduce the cost.

After using the cooker, the housing 40 is vertically upright in a state shown in FIG. 10, and the cooking pan cover 70 is turned and then separated therefrom in the reverse order of its assembling process. After that, the cooked material is drawn from the cooking pan 30. The guiding groove 36 and the vertically turning plate 32 are arranged so that the handle holes 39a of the oil discharging plate 35 are vertically matched with each other. After that, the cooking pan 30 is separated from the housing 40 and then washed.

According to the order and principle described above, the cooker can cook a variety of materials, such as, roast meat, baked fish, meat/fish/chicken boiled with rice, rice-porridge, vegetables, sweet potato, potato, a variety of nuts, etc., oozing oil if they are oily, without burning them.

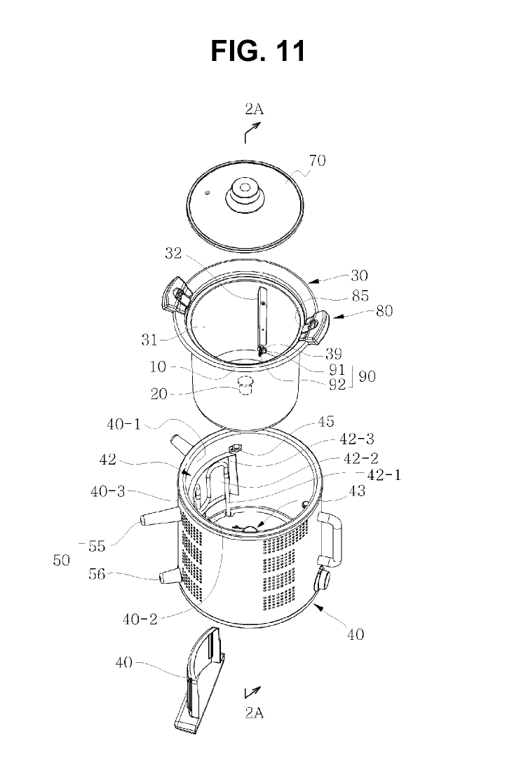

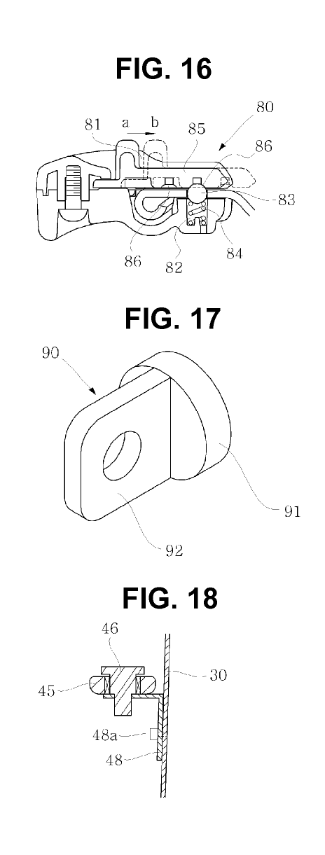

Another embodiment of the invention is described in detail with reference to the accompanying drawings FIGS. 11 to 18.

The cylindrical cooker includes: a cooking pan 30; a housing 40; supports 50; a pair of cooking pan handles 80; and a cooking pan cover 70.

The cooking pan 30 includes an protrusion part 10 extended upwardly from the bottom surface at the center, forming cooking space 31 between the inner wall of the cooking pan 30 and the top side and the lateral side of the protrusion part 10. The protrusion part 10 includes a force transfer unit.

The housing 40 is shaped to be open at the top. The housing 40 includes: a rotation shaft 43 for transferring rotational force from a motor 41 to the force transfer unit 20; a heater 42, installed to the inner wall 40-1, for heating the outer wall of the cooking pan 30; and a cooking pan receiving part 44 for receiving the cooking pan 30. The cooking pan receiving part 44 serves as the inner wall 40-1.

The supports 50 are installed to the outer sidewall 40-3 of the housing 40. The supports 50 support the cooker from the floor at an angle between the floor and the cooker when the cooker is laid down. The heater 42 is placed at an outer side wall of the cooking pan 30 rotating when the cooker is laid down.

The cooking pan handles 80 are located, at the top rim of the cooking pan 30, opposite each other. Each of the cooking pan handles 80 includes a locking member 85.

The cooking pan cover 70 covers the top of the cooking pan 30. The cooking pan cover 70 is rotated with the cooking pan 30 when the cooking pan cover 70 is locked or unlocked by the locking member 85.

The force transfer unit 20 includes: a hollow bolt 23; a supporting unit 24; and a screw nut 28.

The hollow bolt 23 is formed with an angled groove 21. The hollow bolt 23 extends through a center hole 11 of the protrusion part 10 to the inside space 12, and receives rotational force from the rotation shaft 43 of the lower side center.

The supporting unit 24 is integrally formed at the top end of the hollow bolt 23. The supporting unit 24 extends through the outer surface of the protrusion part 10.

The screw nut 28 fixes the hollow bolt 23 to the protrusion part 10, with the screw-couple with the hollowing bolt 23.

The cooking pan 30 further includes one or more vertically turning plates 32 on the inner wall of the cooking space 31. The vertically turning plate 32 is installed so that the lower end is higher than the top of the protrusion part 10.

The cooking pan 30 includes: one or more oil discharging holes 39 on the side wall at the lower portion of the vertically turning plate 32; and an oil discharging container 49 that is moved in a sliding mode and installed at a location between the inner wall 40-1 and the outer sidewall 40-3 of the housing 40, corresponding to the support 50 when the cooker is used in a leaning state. The oil discharging container 49 forms an inner wall oil discharging hole 40-2 on the top side, on the inner wall 40-1, which corresponds to a location where oil is discharged from the oil discharging hole 39. The oil discharging container 49 is formed so that the open top side is located at the inner wall oil discharging hole 40-2.

The cooker further includes a spatula 49a, installed to either side of the inner wall oil discharging hole 40-2, for raking oil from the oil discharging hole 39 toward the oil discharging container 49.

The cooker further includes a block 90, installed to the oil discharging hole 39, for blocking oil from the discharge hole. The block 90 includes: comprises: a blocking valve 91 for blocking the oil discharging hole 39; and a protrusion handle 92 for allowing a user to grip it to perform a blocking or removing operation.

The support 50 includes: a pair of relatively long extension bars 55 extended from the outer side of the housing 40 at the upper location, radially, in the horizontal direction when the cooker is placed on the floor; and a pair of short extension bars 56 extended from the outer side of the housing 40 at the lower location, radially, in the horizontal direction when the cooker is placed on the floor, where the short extension bars 56 are relatively shorter than the long extension bars 55. The short and long extension bars 55 and 56 support the housing 40 from the floor when the cooker is laid down.

The cooking pan receiving part 44 includes: rollers 45, around and on the wall, for allowing the cooking pan 30 to be rotated in the cooking pan receiving part 44 with respect to the center axis of the housing 40.

The heater 42 includes: a heater body 42-1; a thermal insulation plate 42-2; an auxiliary reflection plate 42-3; and a curved net 42-4.

The heater body 42-1 heats the side wall of the cooking pan 30. The thermal insulation plate 42-2 insulates heat from the heater body 42-1 toward the housing 40 and reflects it to the cooking pan 30. The auxiliary reflection plate 42-3 is formed so that the edge of the thermal insulation plate 42-2 is bent. The auxiliary reflection plate 42-3 reflects heat to the cooking pan 30. The curved net 42-4 covers the heater body 42-1 to prevent it from deformation, and retains the spacing between the cooking pan 30 and heater body 42-1.

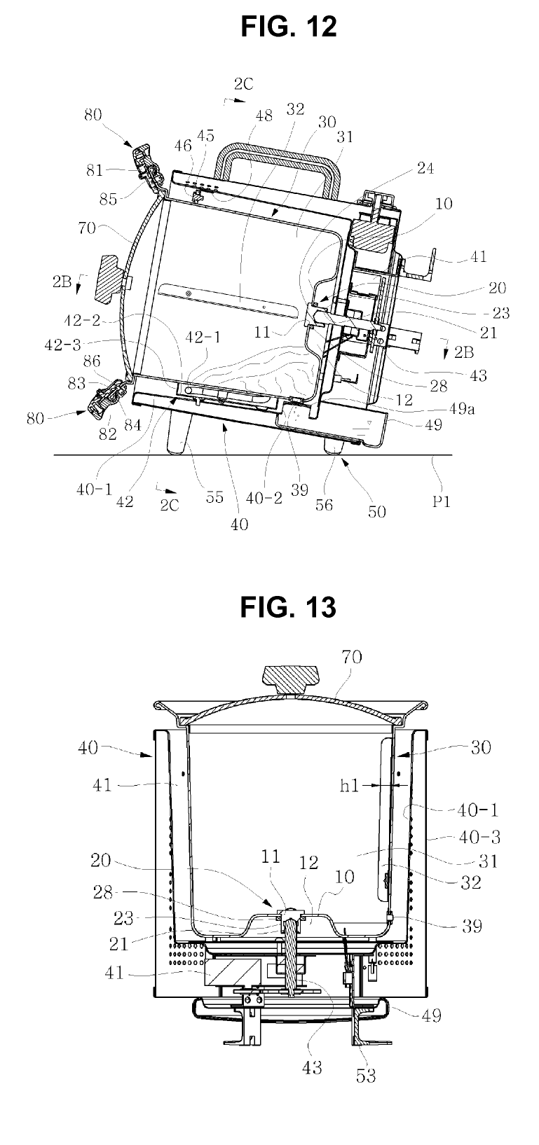

As shown in FIG. 12, the long and short extension bars 55 and 56 have lengths so that they support the cooker from the floor P1 between the floor P1 and the cooker when it is laid down at a range of tilt angle, preferably 5˜15°. If the tilt angle is less than 5°, it increases the cooking time and cooks unevenly. On the contrary, if the tilt angle is greater than 15°, it can decrease the cooking time; however the material may be burned or partially overheated.

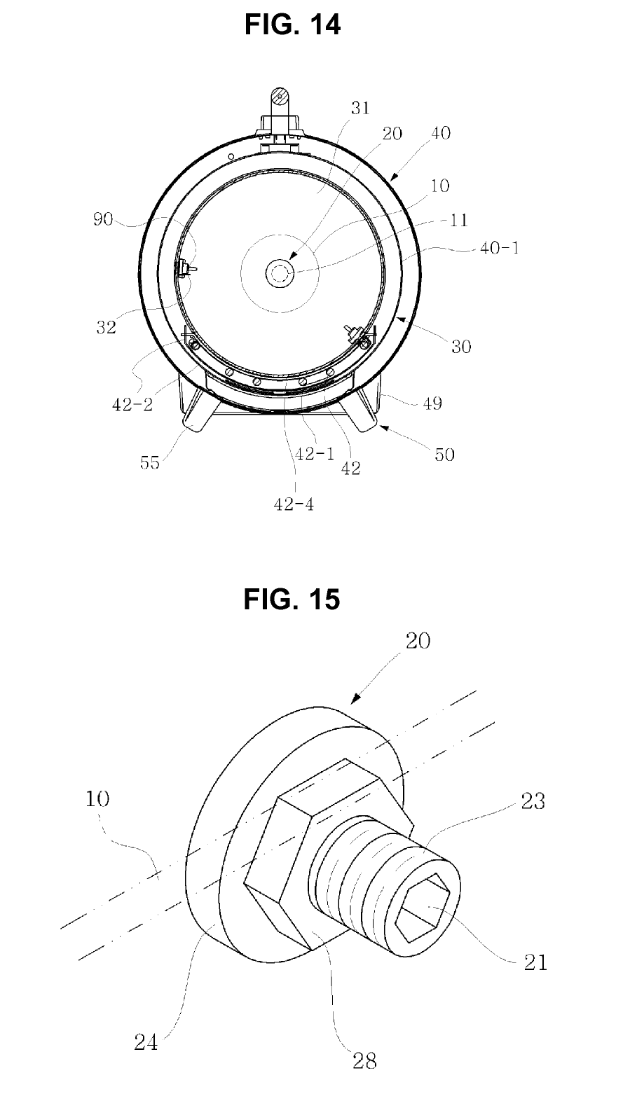

As shown in FIGS. 11 and 14, the vertically turning plate 32 is protruded from the inner wall of the cooking pan 30 at a range of height, h1, preferably 6˜10 mm. If the height is less than 6 mm, material is not turned properly and thus is unevenly cooked. On the contrary, if the height is greater than 10 mm, material is damaged on the surface.

The rotation shaft 43 is coupled to the shaft of the motor 41. In order to prevent the rotation shaft 43 from running at an excessive speed, it is preferable that the motor 41 is implemented with a lower speed motor, a geared motor, or a motor with a speed reduction gear. Therefore, the rotation shaft 43, receiving the rotation force from the motor 41 (force transfer are performed via a pulley belt or a gear mechanism, etc., so the detailed description will be omitted), can be rotated at a low speed. The rotational force is transferred from the motor to the rotation shaft 43 via an angled groove 21 of the force transfer unit 20. The rotation shaft 43 may be designed to form a number of holes for emitting heat shaped as pipes, so as not to be over-heated. Although the embodiment of the invention is implemented in such a way that the angled groove 21 is shaped as an angled form, it may also be noted that the angled groove 21 may be a key spline. The cooker may also include a foot 53 for supporting the housing 40 when it is sit up. The foot 53 may also be used to keep the electric power cord.

The cooker is used for cooking as follows. The protrusion part 10 extends upwardly from the center bottom of the cooking pan receiving part 44 of the housing 40 and includes a force transfer unit 20. The force transfer unit 20 forms an angled groove extending through the body and the rotation shaft 43 also formed as being angled to be coupled with the force transfer unit 20. As shown in FIGS. 11, 12 and 13, the rotation shaft 43 is coupled to the force transfer unit 20 in the cooking pan receiving part 44 in such a way that it is fitted into the angled groove 21 of the force transfer unit 20, located in the inside space 12 of the protrusion part 10 of the cooking pan 30. The cooking pan 30 contains material to be cooked. After assembling the parts described above, the user covers the cooking pan 30 with the cooking pan cover 70. After that, the user presses the locking member 85 of the cooking pan handle 80 and pushes it on an angle so that the locking member 85 can press the upper end of the cooking pan cover 70, thereby mutually coupling each other.

When the cooking pan cover 70 and the cooling pan 30 are locked to each other via the locking member 85, the cooking pan 30 is placed in the housing 40 so that they have the same axis, via a number of rollers 45 that are installed on the inner wall of the cooking pan receiving part 44 and spaced apart from each other at a certain distance. As shown in FIG. 12, when the cooker is laid down and supported via the long extension bars 55 and the short extension bars of the supports 50 from the floor P1 at an angle (e.g., 5˜15°, the housing 40 and the cooking pan 30 are also tilted at the same angle. After that, the cooker is operated by turning on the electric power switch and a control sensor.

As shown in FIG. 12, the heater 42 heats the cooking pan 30 and the motor 41 rotates the shaft at a lower speed. The rotational force is transferred from the rotation shaft 43 to the force transfer unit 20. The force transfer unit 20, integrally installed to the protrusion part 10 of the cooking pan 30, rotates the cooking pan 30. When the cooking pan 30 with an inclination of an angle with respect to the floor is rotated, the vertically turning plate 32, installed on the inner wall of the cooking pan 30, naturally repeatedly turns over the material. Therefore, the material in the cooking pan 30 is evenly, totally cooked without burning. In an embodiment of the invention, the vertically turning plate 32 is protruded from the inner wall of the cooking pan 30 at a range of height, h1, e.g., 6˜10 mm. Therefore, the cooker can evenly cook soft material, such as fish, without damaging it. When the cooker cooks meat that may ooze during cooking, it can discharge oil from the meat to the oil discharging container 49 via the oil discharging hole 39 and the inner wall oil discharging hole 40-2 of the inner wall 41. Therefore, the meat can be cooked without contacting the oozed oil, and this enhances the taste of cooked meat.

The cooker of the invention is designed in such a way that the force transfer unit 20 is installed to the protrusion part 10 extending upwardly from the center bottom of the housing 40 and receives the rotational force from the rotation shaft 43. Since the bottom surface of the housing 40 is even except for the protrusion part 10, the cooking pan 30 can be easily removed from the housing 40 when the cooker is upright on the floor.

In addition, the cooker is designed in such a way that: the heater 42 includes a heater body 42-1 that is spiral, so that it can intensively heat the cooking pan 30; a thermal insulation plate 42-2 supporting the heater body 42-1 blocks heat transfer to the housing 40, thereby protecting the user from heat injuries and an auxiliary reflection plate 42-3 forming an edge surrounding the thermal insulation 42-2 reflects heat to the cooking pan 30, together with the thermal insulation 42-2, thereby maximizing heat efficiency. Therefore, the cooker can cook materials using relatively low heat energy, thereby saving electricity.

After using the cooker, the housing 40 is placed vertically in a state shown in FIG. 12, and the cooking pan cover 70 is turned and then separated therefrom in the reverse order of its assembling process. After that, the cooked material is removed from the cooking pan 30. After that, the cooking pan 30 is separated from the housing 40 and then washed.

According to the order and principle described above, the cooker can cook a variety of materials, such as, roast meat, baked fish, meat/fish/chicken boiled with rice, rice porridge, vegetables, sweet potato, potato, a variety of nuts, etc., oozing oil if they are oily, without burning them.

When the cooker is used to roast sesame seeds or cook materials that may not ooze oil, such as, vegetables, sweet potatoes, etc., the user grips the protrusion handle 92 with the fingers and inserts the block vale 91 to the oil discharging hole 39 so that the cooking pan 30 can be sealed.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The cylindrical cooker is used for cooking foods.

1-20. (canceled)

21. A cylindrical cooker comprising:
a cooking pan rotatable by a predetermined external force and having a barrel shape;
a heater configured to heat the inside of the cooking pan;
a support configured to support a rotation axis of the cooking pan at an predetermined inclination angle between a floor and the rotation axis of the cooking pan;
a tuning plate formed on the inner wall of the cooking pan and protruded toward the inside of the cooking pan; and
a space division tray to be inserted into the cooking pan detachably.

22. The cylindrical cooker according to claim 21, further comprises a protrusion part protruded at a center of a bottom of the cooking pan, and wherein the protrusion part comprises a force transfer unit configured to transfer a rotational force generated from a motor.

23. The cylindrical cooker according to claim 21, further comprises a housing shaped to be open at a top to receive the cooking pan; and a plurality of rollers dispersedly installed between the housing and the cooking pan and supporting the cooking pan to be rotated on an axis equal to an axis of the inner wall of the housing when the cooking pan is being rotated.

24. The cylindrical cooker according to claim 21, wherein the cooking pan comprises an oil discharging hole at the bottom portion of the cooking pan, and an oil discharging container connected to the cooking pan to receive a fluid discharged from the oil discharging hole.

25. The cylindrical cooker according to claim 24, further comprises a block configured to be connected to the oil discharging hole to block the discharge of the fluid, wherein the block comprises a blocking valve for blocking the oil discharging hole and a protrusion handle for allowing a user to grip the block to perform a blocking or a removing operation.

26. The cylindrical cooker according to claim 21, further comprises a concave-shaped drain formed respectively on a plurality of regions of the inside of the cooking pan divided by the space division tray.

27. A cylindrical cooker comprising:
a cooking pan rotatable by a predetermined external force and having a barrel shape;
a heater configured to heat the inside of the cooking pan; and
a tuning plate formed on the inner wall of the cooking pan and protruded toward the inside of the cooking pan.

28. A cylindrical cooker comprising:
a cooking pan rotatable by a predetermined external force and having a barrel shape;
a heater configured to heat the inside of the cooking pan; and
a support configured to support a rotation axis of the cooking pan at an predetermined inclination angle between a floor and the rotation shaft of the cooking pan, and
wherein the cooking pan comprises an oil discharging hole at the bottom portion of the cooking pan, and an oil discharging container connected to the cooking pan to receive a fluid discharged from the oil discharging hole.
